(19) United States
(12) Patent Application Publication
(10) Pub. No.: US 2019/0108706 A1
(43) Pub. Date: Apr. 11, 2019

(54) CASH PROCESSING APPARATUS AND METHOD FOR HANDLING DEFORMED CASH

(71) Applicant: TOSHIBA TEC KABUSHIKI KAISHA, Tokyo (JP)

(72) Inventor: Hidekazu MORI, Mishima Shizuoka (JP)

(21) Appl. No.: 16/151,215

(22) Filed: Oct. 3, 2018

(30) Foreign Application Priority Data
Oct. 11, 2017 (JP) 2017-197730

(51) Int. Cl. G07D 7/187; G07D 11/00

(52) U.S. Cl. CPC G07D 7/187; G07D 11/009; G07D 11/0084

(57) ABSTRACT

A cash processing apparatus comprises a cash insertion port, a cash storage section configured to store cash inserted through the cash insertion port, conveyed along a cash conveyance path, and determined as normal, a circuit arranged along the cash conveyance path and configured to acquire data based on which the cash inserted through the cash insertion port and conveyed along the cash conveyance path is determined as normal, abnormal, or deformed, and a controller configured to determine a total amount of cash inserted through the cash insertion point to be a sum of a first value of the cash determined as normal and a second value of the cash determined as deformed.

### CROSS-REFERENCE TO RELATED APPLICATION

This application is based upon and claims the benefit of priority from Japanese Patent Application No. 2017-197730, filed in Oct. 11, 2017, the entire contents of which are incorporated herein by reference.

### FIELD

Embodiments described herein relate generally to a cash processing apparatus and a method for handling deformed cash.

### BACKGROUND

In recent years, in a retail store such as a supermarket, a department store or a restaurant, a cash processing apparatus which is connected to an electronic device such as a POS (Point Of Sales) terminal is used. The cash processing apparatus receives coins or bills (hereinafter collectively referred to as “cash”) deposited by a customer and stores them in a storage section while dispensing the cash from the storage section based on a dispensing instruction from the electronic device.

The cash processing apparatus identifies denomination, deformation or damage and the like of the cash in the process of storing deposited cash. The cash processing apparatus stores deposited cash in the storage section if the deposited cash is normal cash. On the other hand, if the deposited cash is deformed cash or the like, or if the deposited cash is abnormal cash that cannot be identified (e.g., old money, foreign money, money for game, counterfeit money, etc.), the cash processing apparatus takes countermeasures such as rejecting or discharging the cash to a reception tray which is used normally for dispensing change.

As described above, since the conventional cash processing apparatus takes countermeasures such as rejecting deposited cash when the deposited cash is the deformed cash or the like, it is necessary for a customer to exchange the deformed cash with normal cash. Such a task creates extra work for the customer, and causes delay in a checkout processing.

On the other hand, if the deformed cash or the like is stored in the storage section, there is a risk of clogging due to the deformed cash when dispensing the cash from the storage section.

### DESCRIPTION OF THE DRAWINGS

FIG. 1 is a perspective view of a coin deposit/dispensing device according to an embodiment;

FIG. 2 is a plan view of the coin deposit/dispensing device;

FIG. 3 is a diagram of a separation section and a rejection section;

FIG. 4 is a block diagram illustrating electrical connections of the coin deposit/dispensing device;

FIG. 5 is a functional block diagram illustrating functional components of a controller of the coin deposit/dispensing device; and

FIG. 6 is a flowchart depicting a flow of a coin deposit process according to an embodiment.

### DETAILED DESCRIPTION

In accordance with an embodiment, a cash processing apparatus comprises a cash insertion port, a cash storage section configured to store cash inserted through the cash insertion port, conveyed along a cash conveyance path, and determined as normal, a circuit arranged along the cash conveyance path and configured to acquire data based on which the cash inserted through the cash insertion port and conveyed along the cash conveyance path is determined as normal, abnormal, or deformed, and a controller configured to determine a total amount of cash inserted through the cash insertion point to be a sum of a first value of the cash determined as normal and a second value of the cash determined as deformed.

An embodiment of a cash processing apparatus is described with reference to the accompanying drawings. In the present embodiment, a coin deposit/dispensing device connected to a POS terminal (not shown) used in a retail store such as a supermarket is applied as an example of the cash processing apparatus.

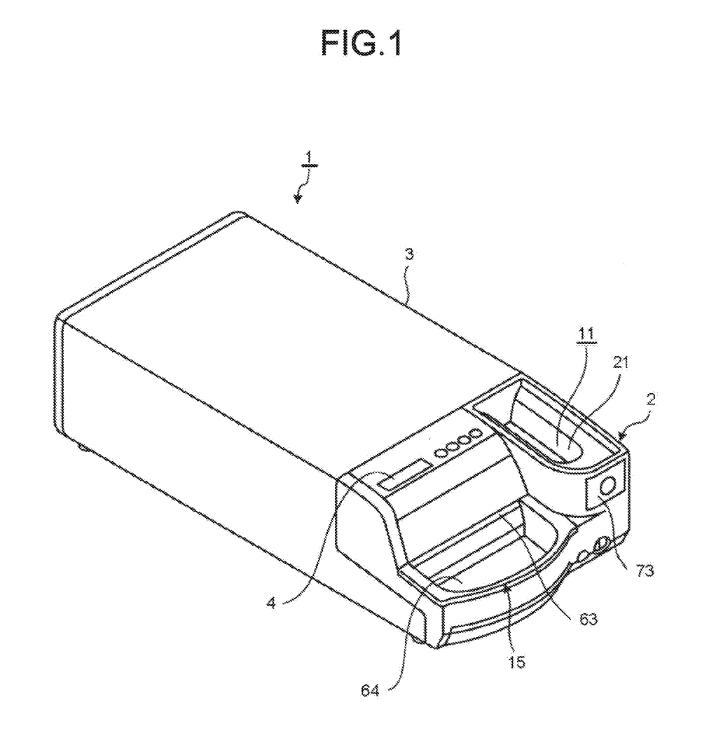

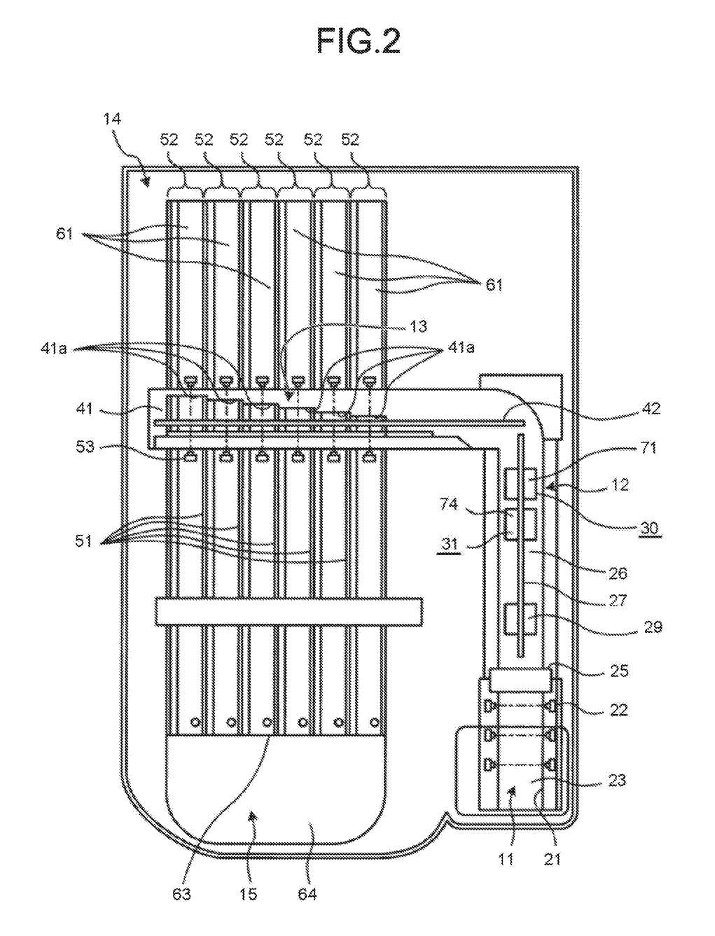

FIG. 1 is a perspective view of a coin deposit/dispensing device 1 according to an embodiment, and FIG. 2 is a plan view of the coin deposit/dispensing device 1. The coin deposit/dispensing device 1 in FIG. 1 is shown by setting a front side for an operator, i.e., a side facing the operator as a front side, and setting a rear side for the operator as a rear side. Hereinafter, expressions such as up and down, right and left, front, back, front surface, and the like in the description using the drawings are expressed when a surface facing the operator is the front surface.

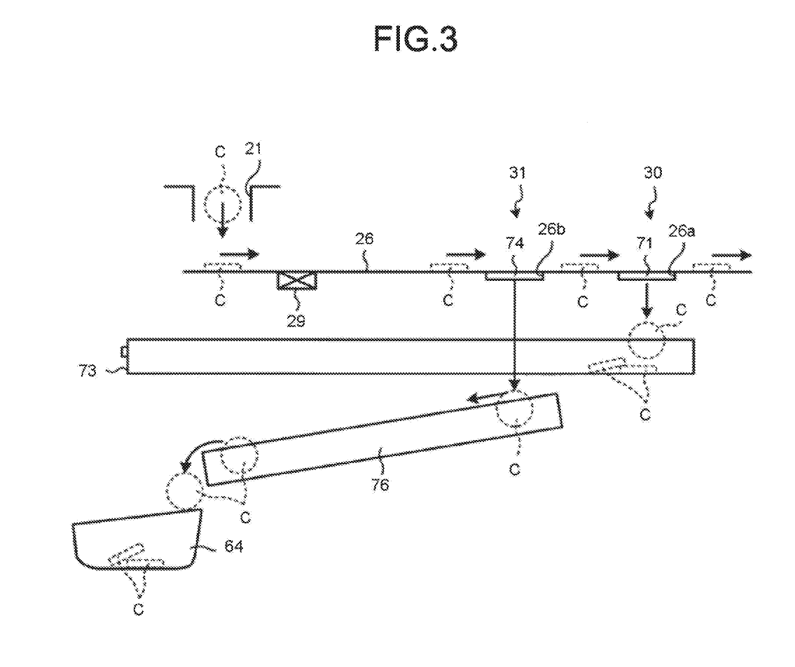

The coin deposit/dispensing device 1 comprises a deposit/dispensing unit 2 by which coin C (refer to FIG. 3) is deposited and dispensed, a housing 3 for accommodating and holding the deposit/dispensing unit 2 in a manner such that the deposit/dispensing unit 2 can be drawn out, and a display device 4 for displaying various messages.

As shown in FIG. 1 and FIG. 2, the deposit/dispensing unit 2 includes a coin reception section 11, a coin conveyance section 12, a coin sorting section 13, a coin storage section 14, and a coin dispensing section 15. The coin reception section 11 is located at a front portion of the coin deposit/dispensing device 1 to receive coins C. The coin conveyance section 12 conveys the coins C received by the coin reception section 11 towards the rear side of the coin deposit/dispensing device 1. The coin sorting section 13 sorts coins C conveyed by the coin conveyance section 12 by denomination. The coin storage section 14 stores the coins C sorted by the coin sorting section 13 by denomination. The coin dispensing section 15 dispenses coins C accommodated in the coin storage section 14.

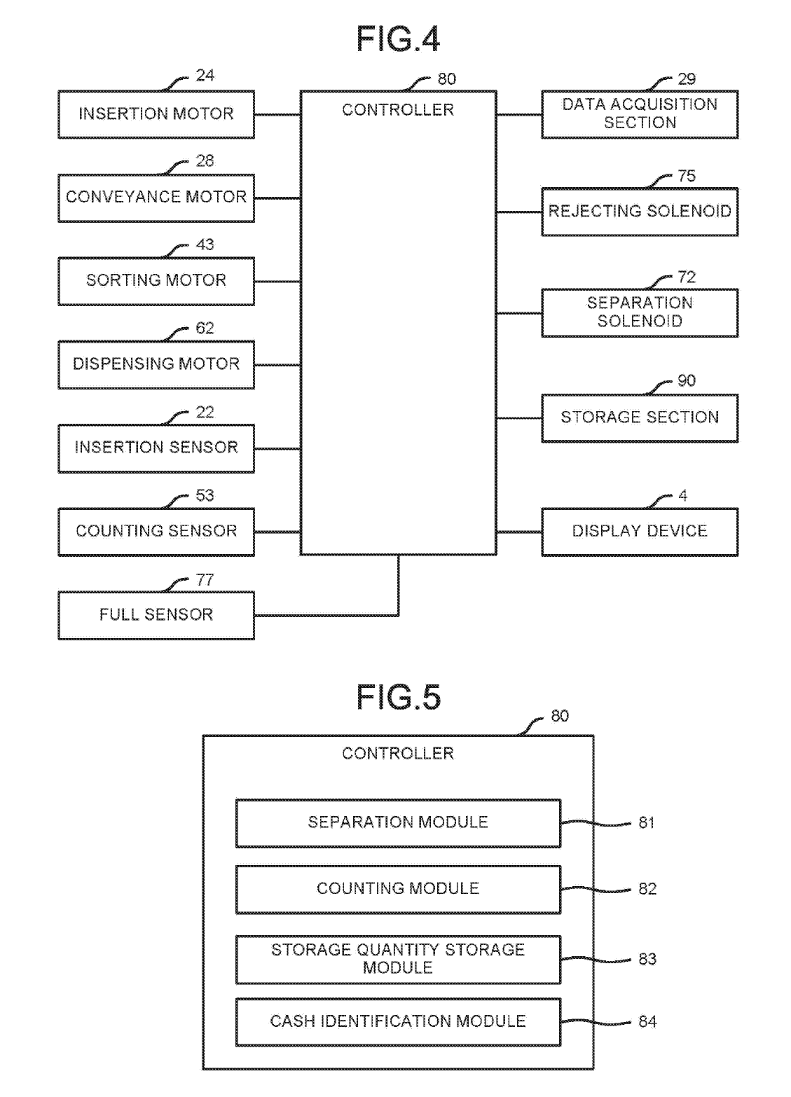

The coin reception section 11 includes a coin slot 21, an insertion sensor 22, an insertion belt 23, an insertion motor 24 (refer to FIG. 4), and an insertion roller 25.

The coin slot 21 has an upper opening that is large enough to permit the deposit of a large number of coins C at the same time. The insertion sensor 22 photoelectrically detects coins C deposited through the coin slot 21. Plural sets of the insertion sensors 22 are provided in the deposit/dispensing unit 2.

The insertion belt 23 forms the bottom of the coin reception section 11. The insertion belt 23 is rotated by driving of the insertion motor 24 to convey the deposited coin C to the inside of the coin deposit/dispensing device 1. The insertion roller 25 faces the insertion belt 23 at a predetermined distance from the insertion belt 23. The insertion roller 25 rotates in the same direction as the insertion belt 23, thereby separating the coins C conveyed by the insertion belt 23 and delivering them one by one.

The coin conveyance section 12 includes a conveyance base 26, a conveyance belt 27, a conveyance motor 28 (refer to FIG. 4), a data acquisition section 29, a separation section 30, and a rejection section 31.

The conveyance base 26 constitutes a conveyance path for the coin C to the coin storage section 14. The conveyance base 26 is provided so as to extend to the rear side from a position where the coin C is received at the insertion belt 23 in a coin conveyance direction.

The conveyance belt 27 conveys the coin C by being rotated by driving of the conveyance motor 28. The coin C is conveyed as the conveyance belt 27 rotates and reaches the coin sorting section 13.

The data acquisition section 29 is provided on the conveyance base 26. The data acquisition section 29 is a circuit that includes a first sensor (not shown) for identifying the material of the coin C and a second sensor (not shown) for detecting a diameter, and discriminates the denomination of the coin C according to the material and the diameter thereof. These sensors are magnetic sensors, each of which has a coil, an oscillation circuit connected to the coil, and a rectifier circuit connected to the oscillation circuit.

The data acquisition section 29 is provided with sensors for identifying presence/absence of a hole, a thickness, a reflectance, an unevenness of surface, and the like of the coin C.

In such a data acquisition section 29, as the coin C approaches the coil, the impedance of the coil changes, and an oscillation level of the oscillation circuit changes accordingly. The rectifier circuit rectifies an output waveform of the oscillation circuit into a waveform corresponding to the digital signal, and outputs it to a controller 80 (refer to FIG. 4) described later.

The amount of change in the oscillation level is set to be different depending on the material of the coin C in the material sensor or the diameter of the coin C in the diameter sensor. The amount of change in the oscillation level in sensors is set to be different depending on the presence or absence of the hole of the coin C, the thickness of the coin C, the reflectance of the coin C, and the irregularity of the coin C.

The separation section 30 and the rejection section 31 are described later.

The coin sorting section 13 includes a sorting base 41, a sorting belt 42, and a sorting motor 43 (refer to FIG. 4). In the sorting base 41, each of sorting holes 41a corresponds to one of the denominations. The widths of each sorting holes become sequentially larger along a coin conveyance direction.

The coin storage section 14 is disposed at a position to receive the coin C falling from the sorting hole 41a. The coin storage section 14 is provided with storage chambers 52 corresponding to respective denominations and partitioned by partition plates 51, and counting sensors 53. The storage chamber 52 communicates with the corresponding sorting hole 41a, and accommodates the coins C falling from the sorting hole 41a by denomination. The counting sensor 53 counts the number of coins C falling into the storage chamber 52.

The coin dispensing section 15 includes a dispensing belt 61, a dispensing motor 62 (refer to FIG. 4), a dispensing port 63, and a reception tray 64. The dispensing belt 61 is driven by the dispensing motor 62 to rotate to convey the coin C from the rear side towards the front side of the coin storage section 14.

The dispensing port 63 is a port through which the coin C conveyed by the dispensing belt 61 is dispensed. The reception tray 64 receives the coin C dispensed through the dispensing port 63.

Next, the separation section 30 and the rejection section 31 are described. FIG. 3 is a diagram of the separation section 30 and the rejection section 31.

The separation section 30 includes a separation shutter 71, a separation solenoid 72 (refer to FIG. 4), and a box 73 to store deformed cash (which, in the embodiments illustrated herein, are deformed coins).

The separation shutter 71 opens and closes a separation hole 26a. The separation hole 26a is a hole formed on the downstream side of the conveyance base 26 in the coin conveyance direction, and has a size that allows the coin C having the maximum diameter to fall. The separation solenoid 72 drives to open and close the separation shutter 71.

The box 73 receives the coin C falling through the separation hole 26a and stores the coin C. As shown in FIG. 1, the box 73 can be drawn out from the front side of the casing 3. The box 73 has a full sensor 77 (refer to FIG. 4). The full sensor 77 is, for example, a transmission sensor. The full sensor 77 detects when the box 73 is full, e.g., when the coin C reaches the uppermost portion of the box 73.

In the present embodiment, the box 73 is used as the deformed coin storage section, but the present embodiment is not limited thereto. The deformed coin storage section may have any configuration as long as it can be drawn out. For example, a side surface of the housing 3 of the coin deposit/dispensing device 1 may be opened and a box-shaped deformed coin storage section may be drawn out. Alternatively, a side surface of the housing 3 may be opened and the coin can be removed directly. For example, deformed coin storage section may be formed in a bag shape.

The rejection section 31 includes a rejection shutter 74, a rejection solenoid 75 (refer to FIG. 4), and a slider 76.

The rejection shutter 74 opens and closes a rejection hole 26b. The rejection hole 26b is formed on the downstream side of the conveyance base 26 in the coin conveyance direction, and has a size that allows the coin C having the maximum diameter to fall. The rejection solenoid 75 drives to open and close the rejection shutter 74.

The slider 76 has a V-shaped cross section. One end of the slider 76 is positioned below the rejection hole 26b, and the other end communicates with the reception tray 64. The slider 76 is inclined in such a manner that the portion below the rejection hole 26b is higher than the end near the reception tray 64. With such a slider 76, the coin C falling through the rejection hole 26b is conveyed to the reception tray 64.

Next, the electrical connections of the hardware components of the coin deposit/dispensing device 1 are described. FIG. 4 is a block diagram illustrating the electrical connection of the coin deposit/dispensing device 1. The coin deposit/dispensing device 1 includes the controller 80 and a storage section 90.

The controller 80 includes a CPU (Central Processing Unit), a ROM (Read Only Memory), a RAM (Random Access Memory), an I/O (Input/Output) device controller, and a communication I/F (Interface), which are not shown. The ROM stores various programs to be executed by the CPU and various data. The RAM temporarily stores programs and data when the CPU executes various programs. For example, the RAM stores a deposit counter for storing a deposit amount.

The controller 80 is connected to the insertion motor 24, the conveyance motor 28, the sorting motor 43, the dispensing motor 62, the insertion sensor 22, the counting sensor 53, the data acquisition section 29, the rejection solenoid 75, the separation solenoid 72, the storage section 90, the display device 4, and the full sensor 77, respectively, to communicate with them.

The controller 80 controls each of the hardware components of the coin deposit/dispensing device 1 by executing the above programs. The controller 80 is directly or indirectly connected to a POS terminal to receive a dispensing instruction or the like from the POS terminal.

The storage section 90 is a flash memory, an HDD, or the like, and stores the information in a rewritable manner. For example, the storage section 90 stores various programs to be executed by the CPU, a first threshold value and a second threshold value used for comparison with an output value of a rectifier circuit of the data acquisition section 29, a log file described later and the like.

The program executed by the coin deposit/dispensing device 1 of the present embodiment may be provided by being recorded in a computer-readable recording medium such as a CD-ROM (Compact Disk Read Only Memory), a FD (Flexible Disk), a CD-R (Compact Disk Recordable), a DVD (Digital Versatile Disk) or the like in a file in an installable format or an executable format.

Furthermore, a program executed by the coin deposit/dispensing device 1 of the present embodiment may be stored in a computer connected to a network such as the Internet, and may be provided by being downloaded through the network. The program executed by the coin deposit/dispensing device 1 of the present embodiment may be provided or distributed via the network such as the Internet.

Characteristic functions among the functions realized by the controller 80 of the coin deposit/dispensing device 1 are described.

Here, FIG. 5 is a functional block diagram illustrating functional components of the controller 80 of the coin deposit/dispensing device 1. By executing the programs stored in the ROM or the storage section 90, the controller 80 functions as a separation module 81, a counting module 82, a storage quantity storage module 83, and a cash identification module 84.

Based on the data acquired by the data acquisition section 29 for the coin C being conveyed on the conveyance path, the cash identification module 84 identifies the denomination when the coin C is normal, and identifies whether the coin C is deformed. More specifically, the cash identification module 84 compares the output value of the rectifier circuit of the data acquisition section 29 with both the first threshold value and the second threshold value, thereby determining whether the coin C is 4 normal, deformed (originally normal, but now with deformation, damage, dirt or the like), or abnormal (e.g., an old coin, a foreign coin, a coin for game, or a counterfeit coin). The first threshold value is a value for determination of the abnormal coin, and the second threshold value is a value for determination of the normal coin. If the output value of the rectifier circuit is between the first threshold value and the second threshold value, the controller 80 identifies the coin C as a deformed coin.

If the box 73 is not full of the deformed coins, the separation module 81 controls the separation section 30 to send the deformed coin identified by the cash identification module 84 to the box 73, and controls the rejection section 31 to discharge the deformed coin identified by the cash identification module 84 if the box 73 is full of the deformed coins.

The counting module 82 adds a total amount of the coins C including the normal coin and the deformed coin as deposit amount to a deposit counter of the RAM. The counting module 82 does not regard the coin C, which is an abnormal coin, as deposited cash.

The storage quantity storage section 83 adds the denominations and the quantity of deformed coins stored in the box 73 to a log file in the storage section 90. The storage quantity storage section 83 also stores the quantity of normal coins stored in the coin storage section 14 by denomination in the log file in the storage section 90.

Next, the operation of the coin deposit/dispensing device 1 when receiving the deposited cash during the sales of a commodity is described.

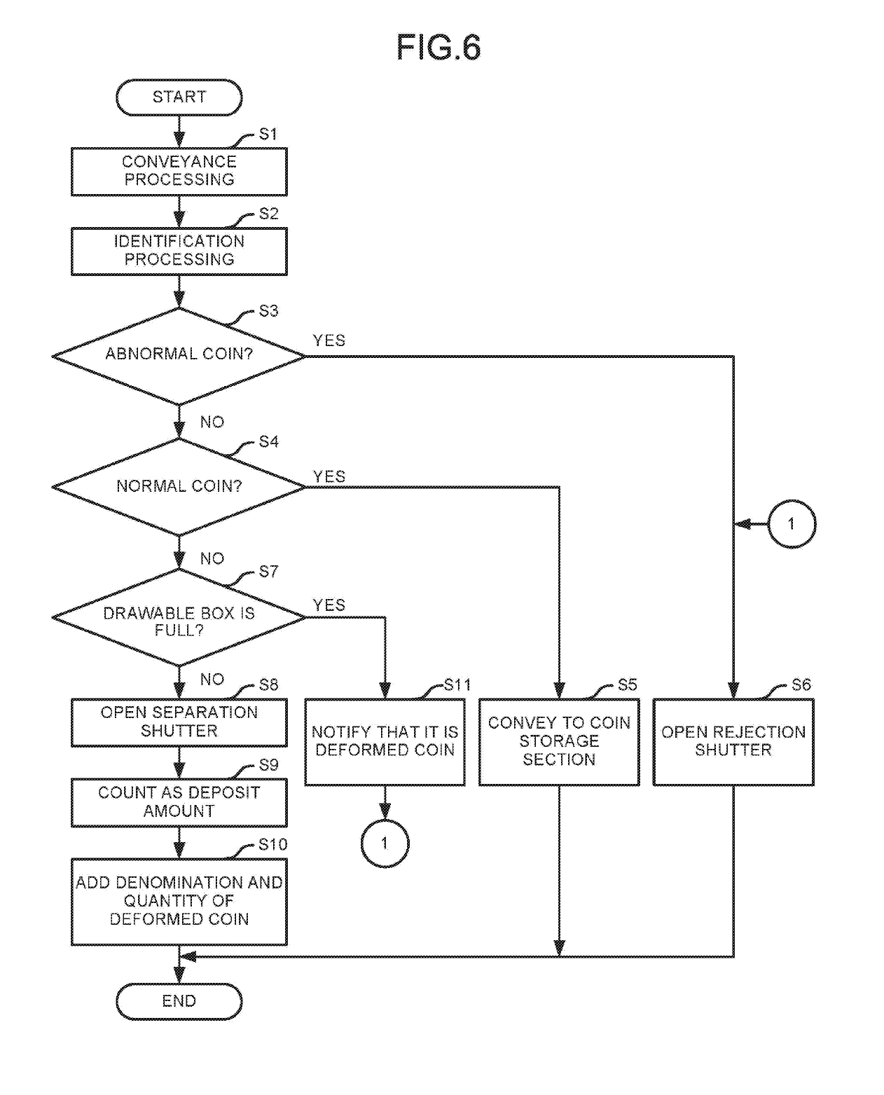

Here, FIG. 6 is a flowchart depicting a flow of a coin deposit processing during the sales of the commodity. As shown in FIG. 6, if the operator inserts the coin C into the coin slot 21, the controller 80 executes a conveyance processing for conveying the coin C (Act S1). More specifically, the controller 80 determines that the coin C is inserted into the coin slot 21 in response to the reception of a signal from the insertion sensor 22. If the insertion of the coin C is determined, the controller 80 drives the insertion motor 24 to rotate the insertion belt 23, and further drives the conveyance motor 28 to rotate the conveyance belt 27.

Next, if the coin C conveyed on the conveyance base 26 passes over the data acquisition section 29, the controller 80, functioning as the separation module 81, executes an identification processing for identifying whether the coin C is the normal coin, the abnormal coin or the deformed coin based on the signal received from the data acquisition section 29 (in particular the first sensor for identifying the material of the coin C) and the first threshold value and the second threshold value stored in the storage section 90 (Act S2).

If the coin C is not the abnormal coin (No in Act S3) and it is the normal coin (Yes in Act S4), the controller 80, functioning as the separation module 81, determines that the coin C is the normal coin. Then, the controller 80, functioning as the separation module 81, controls the conveyance motor 28 to convey the coin C to the coin storage section 14 (Act S5), and terminates the present processing.

On the other hand, if it is determined that the coin C is the abnormal coin (Yes in Act S3), the controller 80, functioning as the separation module 81, controls the rejection shutter 74 to open (Act S6) and to reject and discharges the coin C to the reception tray 64, and to terminate the present processing.

If it is determined that the coin C is the deformed coin (i.e., a normal coin that has been deformed) whose denomination can be identified (No in Act S4), the controller 80, functioning as the separation module 81, determines whether the box 73 is full of the deformed coins based on a signal from the full sensor 77 (Act S7).

If it is determined that the box 73 is not full of the deformed coins (No in Act S7), the controller 80, functioning as the separation module 81, controls the separation shutter 71 to open (Act S8) and stores the coin C in the box 73.

Then, the controller 80, functioning as the counting module 82, adds the amount of the coin C to the deposit counter as deposit amount (Act S9).

Further, the controller 80, functioning as the storage quantity storage module 83, adds the denomination and the quantity of the deformed coin to the log file (Act S10), and terminates the present processing.

As described above, according to the coin deposit/dispensing device 1 of the embodiment, it is possible to handle the normal coin, the deformed coin and the abnormal coin differently. According to the coin deposit/dispensing device 1 of the present embodiment, by storing the deformed coin separately from the normal coin while adding the amount of the deformed coin to the total deposit amount, it is possible to prevent the deformed coin from being further circulated. As a result, it is possible to automate the deposit of the normal coin also including a coin that is deformed but the denomination thereof can be identified, which reduces the time and labor of an operator, and it is also possible to eliminate possibility of displeasing a customer by dispensing the deformed coin as change. Furthermore, according to the coin deposit/dispensing device 1 of the embodiment, since the deformed normal coin is not conveyed to the coin storage section 14, the possibility of clogging at the time of dispensing can be reduced.

On the other hand, if it is determined that the box 73 is full of the deformed coins (Yes in Act S7), the controller 80, functioning as the separation module 81, notifies that it is the deformed coin (Act S11), opens the rejection shutter 74 (Act S6), rejects and discharge) the coin C to the reception tray 64, and terminates the present processing.

The controller 80, functioning as the separation module 81, notifies that the coin C is the deformed coin by controlling the display device 4 of the coin deposit/dispensing device 1 to display a message or by executing a process to send a message to the POS terminal.

Specifically, if the box 73 is full of the deformed coins, the customer, after having received a message that the coin C is deformed, needs to replace the coin C with other coins, or the operator needs to replace the coin C with coins managed separately. In such situations, the coin deposit/dispensing device 1 cannot consider the total amount of the deformed coins as adding to the total deposit amount.

As described above, according to the coin deposit/dispensing device 1 of the embodiment, if the deposited coin is the deformed coin suffering from deformation or the like, it is possible to reduce labor and time taken to replace the coin, and it is also possible reduce a risk of occurrence of clogging caused by the deformed coin suffering from the deformation or the like.

Furthermore, according to the coin deposit/dispensing device 1 of the embodiment, if the box 73 is full of the deformed coins, which cannot be used as the change due to dirt, deformation or the like although determined as the coin by the controller 80, functioning as the separation module 81, the deformed coin is rejected and discharged to the reception tray 64. Therefore, the operator does not need to stop the checkout processing to collect the deformed coin in the box 73, and can continue the checkout processing.

In the present embodiment, the deformed coin is stored in a single deformation storage section (i.e., box 73), but in the process of implementation, a deformed cash storage section may be composed of several storage chambers for storing the deformed coins by denomination in accordance with the number of denominations, and the deformed coins may be stored separately for each denomination in such a manner that the deformed coins having the same denomination are stored in the same storage chamber.

Further, in the present embodiment, the coin deposit/dispensing device 1 for depositing and dispensing coins is described as the cash processing apparatus, but the present embodiment is not limited thereto. For example, a bill deposit/dispensing device for depositing and dispensing bills may be used as the cash processing apparatus.

In the present embodiment, the coin deposit/dispensing device 1 connected to the POS terminal is applied to the cash processing apparatus, but the embodiment is not limited thereto. For example, as the cash processing apparatus of the present embodiment, a deposit/dispensing apparatus built in an ATM (Automated Teller Machine) may be used. The above configuration may be applied to the cash processing apparatus which performs either deposit or dispensing.

A single device having the functional components of both the coin deposit/dispensing device 1 and POS terminal may be applied to the cash processing apparatus. Specifically, the cash processing apparatus is a self-checkout apparatus used in a retail store such as a supermarket and a convenience store.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A cash processing apparatus, comprising:
a cash insertion port;
a cash storage section configured to store cash inserted through the cash insertion port, conveyed along a cash conveyance path, and determined as normal;
a circuit arranged along the cash conveyance path and configured to acquire data based on which the cash inserted through the cash insertion port and conveyed along the cash conveyance path is determined as normal, abnormal, or deformed; and
a controller configured to determine a total amount of cash inserted through the cash insertion point to be a sum of a first value of the cash determined as normal and a second value of the cash determined as deformed.

2. The cash processing apparatus according to claim 1, further comprising:
a change tray to which the controller discharges change.

3. The cash processing apparatus according to claim 2, further comprising:
a cash conveyance guide configured to guide the cash determined as deformed to be discharged to a deformed cash storage section and the cash determined as abnormal to be discharged to the change tray.

4. The cash processing apparatus according to claim 2, further comprising:
a cash conveyance guide configured to guide the cash determined as deformed to be discharged to a deformed cash storage section if the deformed cash storage section is not full and to the change tray if the deformed cash storage section is full.

5. The cash processing apparatus according to claim 4, further comprising:
a display on which a message about the cash determined as deformed is displayed when the deformed cash section is full and the cash determined as deformed is discharged to the change tray.

6. The cash processing apparatus according to claim 4, wherein the cash conveyance guide includes a first shutter that opens to a first discharge path to the change tray and a second shutter that opens to a second discharge path to the deformed cash storage section.

7. The cash processing apparatus according to claim 6, wherein the second shutter is downstream of the first shutter in the cash conveyance path.

8. The cash processing apparatus according to claim 1, wherein the circuit includes a first magnetic sensor configured to detect a material of the cash conveyed along the cash conveyance path and a second magnetic sensor configured to detect a diameter of the cash conveyed along the cash conveyance path.

9. The cash processing apparatus according to claim 8, wherein the controller determines the cash as normal if an output of the first magnetic sensor is above a first threshold, as abnormal if below a second threshold, and deformed if between the first and second thresholds.

10. The cash processing apparatus according to claim 1, wherein the cash inserted through the cash insertion port and conveyed along the cash conveyance path is a coin.

11. A cash processing method in connection with a payment for products or services, comprising:
determining cash inserted through a cash insertion port and conveyed along a cash conveyance path is one of normal, abnormal, or deformed;
determining a total amount of cash inserted through the cash insertion point to be a sum of a first value of the cash determined as normal and a second value of the cash determined as deformed; and
discharging change to a discharge tray, the change being determined as a difference of the sum of the first value and the second value and the payment owed for the products or services.

12. The cash processing method according to claim 11, wherein the payment owed is acquired from a point-of-sale terminal.

13. The cash processing method according to claim 12, further comprising:
discharging the cash determined as deformed to a deformed cash storage section and the cash determined as abnormal to the change tray.

14. The cash processing method according to claim 12, further comprising:
discharging the cash determined as deformed to a deformed cash storage section if the deformed cash storage section is not full and to the change tray if the deformed cash storage section is full.

15. The cash processing method according to claim 14, further comprising:
displaying a message about the cash determined as deformed when the deformed cash section is full and the cash determined as deformed is discharged to the change tray.

16. The cash processing method according to claim 14, further comprising:
operating a first shutter to provide access to a first discharge path to the change tray; and
operating a second shutter to provide access to a second discharge path to the deformed cash storage section.

17. The cash processing method according to claim 16, wherein the second shutter is downstream of the first shutter in the cash conveyance path.

18. The cash processing method according to claim 11, further comprising:
detecting a material of the cash conveyed along the conveyance path using a first magnetic sensor; and
detecting a diameter of the cash conveyed along the conveyance path using a second magnetic sensor.

19. The cash processing method according to claim 18, wherein the cash is determined as normal if an output of the first magnetic sensor is above a first threshold, as abnormal if below a second threshold, and deformed if between the first and second thresholds.

20. The cash processing method according to claim 11, wherein the cash inserted through the cash insertion port and conveyed along the cash conveyance path is a coin.
